(19) United States
(12) Patent Application Publication
(10) Pub. No.: US 2004/0015483 A1
(43) Pub. Date: Jan. 22, 2004

(54) Document tracking system and method

(76) Inventor: Ronald W. Hogan, Marietta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/195,939

(22) Filed: Jul. 16, 2002

(51) Int. Cl. G06F 17/30

(52) U.S. Cl. 707/3

(57) ABSTRACT

A legislative, regulatory or similar process tracking system and method for finding and presenting a composite view of the real-time status of a specific document or documents of interest and other related information generally contained in supporting documents and/or in entirely separate databases. The supporting documents and status information generally are not available utilizing traditional searching methods and can provide the most or only relevant information for tracking the status of the specific documents of interest as they move through the legislative, regulatory or similar process.

### BACKGROUND OF THE INVENTION

1. Field of the Invention

The present invention relates generally to real-time searching technology and more specifically relates to a document tracking system and method for finding and presenting a composite view of the real-time status and other information of a specific legislative, regulatory or similar process document or documents of interest and other related information generally contained in supporting documents and/or in entirely separate databases. The supporting documents and status information generally are not available utilizing traditional searching methods and can provide the most or only relevant information for tracking the status of the specific documents of interest as they move through the legislative, regulatory or similar process.

2. Description of the Prior Art

Search engines and techniques of various types have been in use for many years directed to accomplishing many types of information and document searches. These techniques have been especially developed and refined for obtaining desired data from the voluminous amount of information made available using the Internet and the World Wide Web (WEB). The WEB has effectively made virtual libraries instead of bound volumes, because physical volumes of information are not required to reside in a single library or other physical location.

The WEB potentially has over eighty million digital forms of publications, representing trillions of pages of information. The volume of the potential information is staggering, however, the reality of information readily accessible is less so. The majority of research quality information is partially or completely inaccessible using conventional information search engines and techniques. Some of the information is inaccessible, since it resides on proprietary databases, which are not generally accessible using the WEB. These proprietary databases typically are provided by commercial database providers and access generally is granted only on a paid subscription basis. Consequently a person interested in obtaining information from these proprietary databases must subscribe to each individual database provider.

Further the information content in a large number of publicly accessible WEB databases, such as the US Patent and Trademark Office's patent and trademark databases, are not directly available using conventional search engines from Yahoo and Northern Light. While the search engine may be able to identify and return a hyperlink or universal resource locator (URL) for the database, the search engine is unable to search for information within the database. Consequently, the person searching must go directly to the database website to obtain the information.

Of particular significance, many database providers design their own databases, using their own specific requirements and specifications. While these databases can be accessed via the WEB, through a database interface, these interfaces vary among the various providers. Because of these differences, the person interested in retrieving information from these various databases is required to access each database separately.

For example, an organization, such as a company may subscribe to a number of the database providers in order to obtain access to various types of information of interest to users in the organization. To provide convenient access to many individual users, access is typically provided on a company intranet via use of click able icons, which are made accessible to the users. Each separate icon generally represents a database link, which upon activation establishes access to a particular database. As a result, the user has to activate (click) a particular corresponding icon each time that access is desired to that particular database. This is so, even though the identical subject matter search is being done on each database.

Furthermore, even though some of the proprietary databases allow access from the WEB via WEB-enabled interfaces, each of the proprietary databases still must be accessed separately by the user. For example, in order to access the proprietary databases via the WEB, the user will use their WEB browser to connect to the database provider's website and then access the proprietary database via an interface. If the user subsequently wishes access to another proprietary database, the user will have to exit the first database provider's website and then connect to the other provider's website to access the other database. As a result, separate and sequential accesses are required for the user to access each of the different proprietary databases.

The problems presented by accessing the various databases are illustrated by the example of trying to track information in the legislative process. According to the Council of State Governments and the Library of Congress, during the 1996 to 1997 legislative session, over 238,000 pieces of legislation were introduced in Congress and the state legislatures. By taking multiple legislative bill versions, which might change on a daily basis, into account (amendments, revisions, substitutions, etc.), the total of distinct documents approaches or exceeds a million. Each state and Congress also maintains a bill status document for each piece of legislation. Many states also maintain additional (supporting) documents that relate to each bill, such as summary documents, fiscal notes, voting records, sponsors and so forth. These additional supporting documents easily push the total distinct legislative documents well over two million total documents.

Much emphasis is placed upon the ocean of information available on the Internet, but much less emphasis has been placed on how users of the WEB might actually be able to obtain and use the information. Currently, the only way to obtain the latest information on legislation of a particular nature (like Medicare or environmental/waste water) via the Internet is to find and access the web page for each state's search engine. The search term or expression then is entered in the method prescribed for each state, for example using Boolean logic. Each bill found then is reviewed to determine the bills of interest. In many cases, the state's search engine will present all bill versions, thus significantly increasing the time and concentration it takes the user to find the latest version of each bill and determine if the bill or any revisions are of interest. The bill numbers then are logged manually or by cutting and pasting into a user document.

Once a bill of interest is found, though, it then is imperative to place the bill into its proper political perspective. For example, the identity of the bill's author (an element frequently not found on the legislative document itself) is important and can significantly impact the bill's progress or lack thereof through the legislative process. The current status of the bill is important in developing and carrying out an effective lobbying approach to amend, promote or defeat a particular piece of legislation. Fiscal notes that have been prepared indicate, for better or worse, the financial impact on the public or business interests and can be extremely helpful in any lobbying effort. All of these supporting documents and others are separate from, but are critical in determining a proper response to each bill of interest. While the language of the bill or document, in and of itself, initiates the user's or searcher's level of interest, it is the supporting documents that often trigger action on the part of the user.

While finding legislative or regulatory documents or bills of interest is conducted using conventional search engine technology, finding the essential supporting documents about each of the bills is not so available. In fact, it is a manual, time-consuming and often confusing process that is not made available through, nor does it lend itself to use of standard search engine techniques. As previously mentioned, once a bill or document of interest has been located, it then is critical to determine where the bill is in the legislative or regulatory process—its status. The user or searcher then must go to another web page on the state's WEB site and manually and individually enter each bill's type and number, such as House Bill (HB) 124; review the status of each individual bill; review the current/final version or date to determine if the bill has had any action taken upon it in a particular time period or since last reviewed (the lack or presence of activity most often being the primary and controlling concern of the user with regard to each bill); write down or cut-and-paste the pertinent new bill actions and then input the information by hand into some form of report to be saved for future reference. Access to other supporting information, such as voting records, committee hearings and fiscal notes, is obtained in the same tedious manner.

That is the search process for just one bill/issue in one state. If there are multiple issues, then the searcher must repeat this process for each issue. Multiple states that have the issue of interest also will require the repetition of the search process, although each state may require that a different search logic be utilized. As a user finds more information/bills of interest, the user is required to analyze more and more data and quickly arrives at a point of diminishing returns. A further not insignificant problem is the different formats that the information is provided in. This requires a user to spend time finding the relevant information in each different source and different document.

In tracking legislation, there exists a problematic issue that is not applicable to normal search engine technology and that is the fact that the majority of legislatures impose some form of deadline on the introduction of bills. Once the respective deadline is passed, future use of a search engine in those states only serves to provide a link to all bills that include those keywords and/or phrases, through which the searcher or user must cull each time, those bills of interest. Change detection technology is not incorporated into the stare or congressional search engines. Even if it were, in some instances such as in Tennessee, changes, amendments and/or bill substitutes are kept as separate non-searchable documents.

Finally, and possible most importantly, change is not a requirement for a bill to be enacted into law, thus further limiting the utility of standard search engine technology and, in many cases, nullifying the utility of change detection techniques, even if they were present. Thus, the utility of the respective state and congressional search engines wanes, but the legislative process continues. Companies have quickly realized that this is not an efficient utilization of the searcher's time and often does not result in reports of more than minimal use.

There have been established, commercial services to provide the tracking information to companies. The commercial services of course charge for their services, but either input the data manually themselves, use web crawlers on a periodic basis, such as nightly, or use some combination of both. Generally, the services copy the full text of a bill of interest and then compare it with the next data capture. While this does produce whatever changes may be made to the bill text, status and other information in the supporting documents, it is at best only current as of yesterday's information. In many cases, the information is several days to over a week out of date. Further, many states provide updates throughout each day so that the status and any other changes are readily available in real-time. Thus the companies have a choice of going directly to the various state databases themselves for timely but cumbersome retrieval of the information of interest or pay the commercial service for outdated and generally incomplete data.

It thus would be desirable to provide a dynamic, real-time tracking system and method for legislative, regulatory or similar processes via the Internet, which provides efficient substantially simultaneous access to multiple databases and generates user-friendly reports, including relevant supporting document information.

### SUMMARY OF THE INVENTION

The present invention provides a legislative, regulatory or similar process tracking system and method for finding and presenting a composite view of the real-time status of a specific document or documents of interest and other related information generally contained in supporting documents and/or in entirely separate databases. The supporting documents and status information generally are not available utilizing traditional searching methods and can provide the most or only relevant information for tracking the status of the specific documents of interest as they move through the legislative, regulatory or similar process.

The tracking system and method include using a search expression to search selected entities, such as state legislatures to find documents containing the search expression. The information in the documents then is used to find the supporting documents, which contain the status and other information of interest. The status and other information of interest are used to generate a composite status report.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways and is only limited to the claims attached hereto. Also, it is to be understood that the phraseology and terminology employed herein are for the purpose of the description and should not be regarded as limiting the scope of the present invention.

To accomplish the above and related functions and features, this invention may be embodied in the form illustrated in the accompanying drawings, attention being called to the fact, however, that the drawings are illustrative only, and that changes may be made in the specific construction illustrated without departing from the scope of the present invention.

### BRIEF DESCRIPTION OF THE DRAWINGS

Various other functions, features and attendant advantages of the present invention will become fully appreciated as the same becomes better understood when considered in conjunction with the accompanying drawings, in which like reference characters designate the same or similar parts throughout the several views, and wherein:

FIG. 1 is an illustration of a block diagram of one embodiment of the tracking system of the present invention.

FIG. 2 is an illustration of a diagram of the general operation of the present invention.

FIG. 3 is an illustration of an initial search embodiment operation of the present invention.

FIG. 4 is an illustration of a first saved search embodiment operation of the present invention.

FIG. 5 is an illustration of a second saved search embodiment operation of the present invention.

FIG. 6 is an illustration of a topical category saved search embodiment operation of the present invention.

FIG. 7 is an illustration of one embodiment of a login screen shot of the tracking system of the present invention.

FIG. 8 is an illustration of one embodiment of a combined search expression and entity screen shot of the tracking system of the present invention.

FIG. 9 is an illustration of one embodiment of a composite standard search report screen shot of the tracking system of the present invention.

FIG. 10 is an illustration of one embodiment of a saved search report screen shot of the tracking system of the present invention.

FIG. 11 is an illustration of one embodiment of an edit notes screen shot of the tracking system of the present invention.

FIG. 12 is an illustration of one embodiment of a user saved search screen shot of the tracking system of the present invention.

FIG. 13 is an illustration of one embodiment of implementing a search of a user saved search screen shot of the tracking system of the present invention.

FIG. 14 is an illustration of one embodiment of a search report from a search of a user saved search screen shot of the tracking system of the present invention.

FIG. 15 is an illustration of a second embodiment of a search report from a search of a user saved search screen shot of the tracking system of the present invention.

FIG. 16 is an illustration of a third embodiment of a search report from a search of a user saved search screen shot of the tracking system of the present invention.

### DETAILED DESCRIPTION OF THE INVENTION

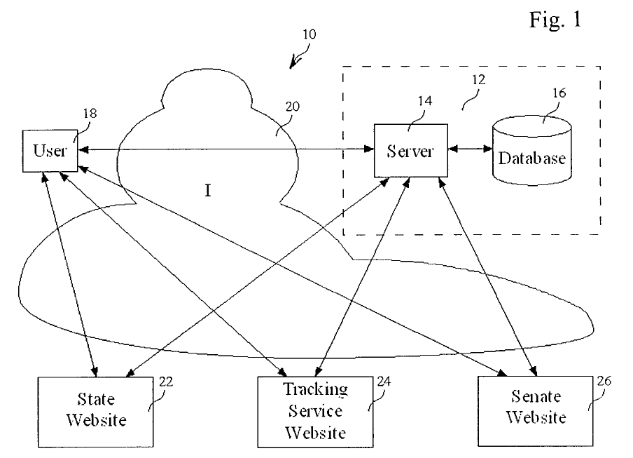

Referring now descriptively to the drawings, in which the same reference characters denote the same or similar elements throughout the Figures, a block diagram of one embodiment of a legislative, regulatory or similar process tracking system and method for finding and presenting a composite view of the real-time status of a specific document or documents of interest and other related information of the present invention is designated by the reference numeral 10 in FIG. 1. The system 10 includes a data processor or computer system 12 having at least a server 14 coupled to a database 16. The data processor 12 includes the elements necessary to perform the functions enumerated for the tracking process of the invention, but can include a variety of configurations and individual elements (not illustrated), as desired. A user will communicate with the server 14 using a PC, PDA or conventional computer 18, typically via the Internet (I) 20.

As described in further detail hereinafter, the user will use the computer 18 to select and send a search expression via the Internet (I) 20 to the server 14 along with the selection of one or more search entities. A search expression can typically include keywords and phrases, specific document names/addresses/URL's, or categories/groups/classes/types of documents, or any combination thereof. The data processor 12 then will use the server 14 to search the selected entity or entities again via the I 20. Although, only three entities are illustrated, a state website 22, a tracking service website 24 and a senate website 26, any number of or all state legislative websites and regulatory websites, as well as similar process websites can be used. As used herein, “process” (a legislative, regulatory or similar process) means any routine(s), function(s), procedure(s), operations(s), actions(s), activity(ies) or other substantially set sequence of steps taken upon, assigned to, associated with, required or expected of, or taken upon a document or set of documents; the relative position of a document in a graded series, or any maneuvers or commentary made upon or on behalf of a document(s) as part of progress toward a goal.

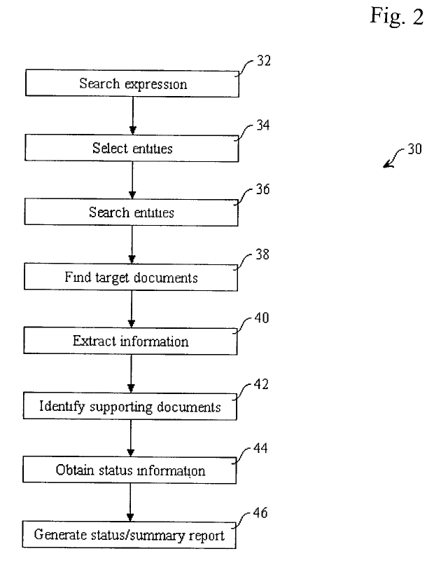

Referring now also to FIG. 2, a flow chart 30 of the basic operation of the present invention is illustrated. The user enters a search expression in the computer 18 in a step 32 and then selects the entity(ies) to search in a step 34. The computer 18 then communicates these selections to the processor 12, which can be done together or individually in either order. The search expression can be anything of interest, such as “environmental/waste water” in one or all state websites. The search expression also can be as simple as a single pre-identified bill or regulation in a single state website, such as Senate Bill (SB) 32 in the Georgia website. The system 10 then uses the selections in a step 36 to search the selected entity, such as the state website 22. The server 14 finds the target documents of interest in a step 38 and extracts the information of interest in a step 40. The data processor 12 at least identifies the supporting document(s) in a step 42 and from them at least obtains the status information in a step 44. The data processor 12 then generates and sends to the user a summary/status report, preferably a standard format user-friendly document, in a step 46. The report preferably contains links such that the user can go directly to the website 22, 24 and/or 26 to directly review the target and supporting documents. The supporting documents often are the most important sources of information, such as the author, summary, status, votes, upcoming hearing schedules, etc. Most of the supporting documents will not contain the search expressions in the target document searches and most often are not made searchable on the website.

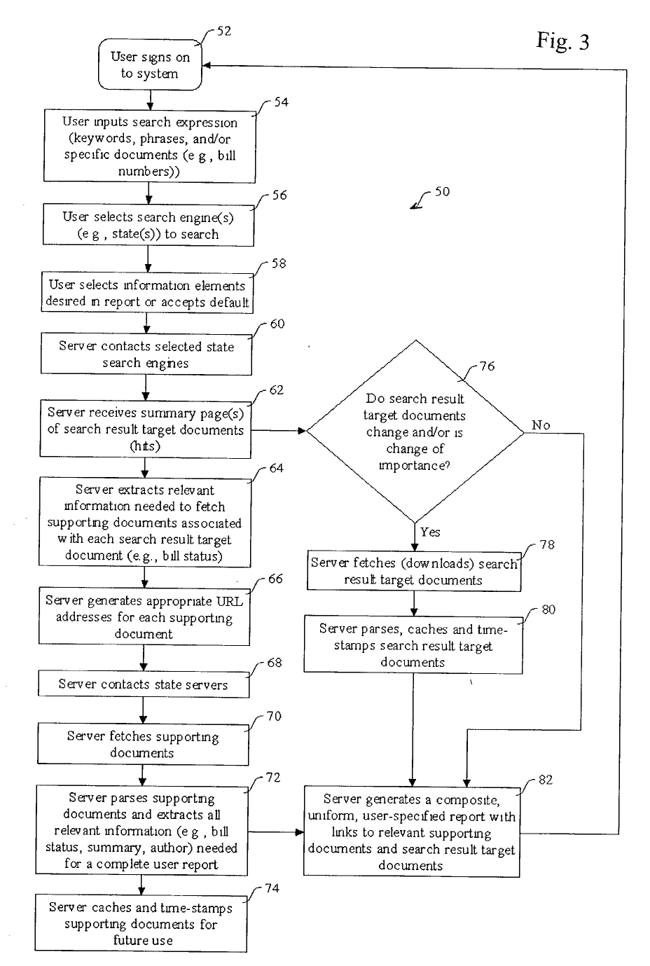

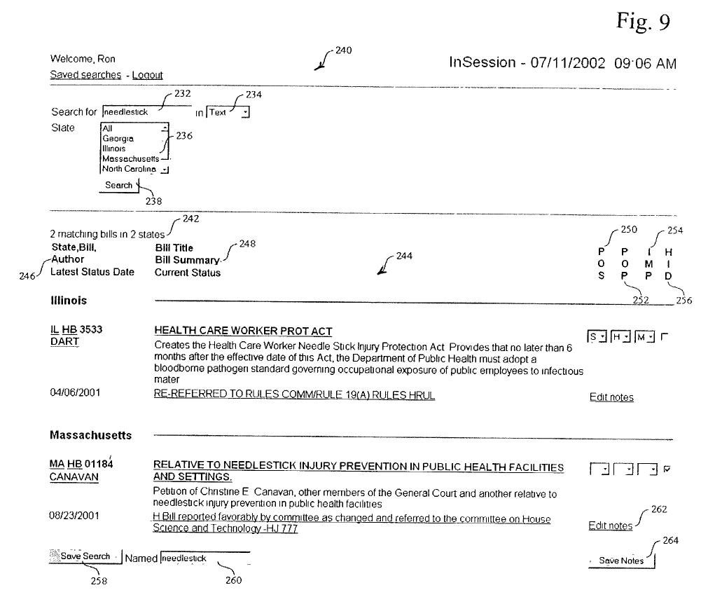

Referring now to FIG. 3, an initial detailed search embodiment flow chart 50 is illustrated. The user/searcher signs on to the system 10, such as by using the computer 18 via the I 20, by a direct link or by a local input to the data processor 12 in a step 52. The sign on can include the appropriate and conventional security measures, such as the use of a password. The user then selects the search expression in a step 54. The search expression can be most any searchable concept, such as a keyword, like “environment”, or a phrase such as “waste water treatment” or a specific regulation(s) or bill number(s) or a combination, such as when a bill is known in one state and the general phrase then is searched in other states. The user then selects a search entity(ies) or engine(s) in a step 56. This can be a default selection also, such as all available websites or all states. The data processor 12 preferably includes a standard default report (see FIG. 9), but which can be modified if desired by the user in a step 58.

The server 14 then contacts the selected entities in a step 60 to find any target documents containing the selected search expression(s). The data processor 12 has stored the search formats and all other necessary procedures and document formats for each entity in the database 16. Thus, the server 14 will have the necessary information to find and to analyze the target and supporting documents found at each selected website, without requiring any input from the user. The server 14 receives either a summary page listing the target documents or the document itself if only one document is requested in the search expression found from each website searched in a step 62. The server 14 then extracts the relevant information from the summary pages or the resulting document itself to obtain the supporting documents, which are associated with each target document in a step 64. The server 14 then generates an appropriate address, such as a URL, for each of the supporting documents in a step 66. The server 14 then contacts each of the selected entities in a step 68 and obtains the supporting documents in a step 70. The server 14 then parses the supporting documents and extracts all relevant information, which is required to generate the default, or modified user report in a step 72. The server 14 preferably caches and time-stamps the supporting documents obtained for future use in a step 74.

When the server 14 obtains the target document summary pages in the step 62, a decision is made in a step 76 on whether or not the target document will change and if so, whether the change is of importance. The server 14 makes the decision based upon pre-existing programming built into it and designed to factor in whether each state denotes changes in the target documents (i.e., bills) or not. If the answer is yes, then the server 14 obtains the target documents themselves in a step 78. The server 14 then parses the text for future comparison, caches and time-stamps the target documents for future use in a step 80. The server 14 then generates a composite, uniform user-specified report with links to the relevant supporting documents and their associated target documents in a step 82. If the answer to the decision in the step 76 is no, then the report is generated without first proceeding with the steps 78 and 80. In either case, the report is stored in the database 16 and sent to the user for use as it is or storage on the computer 18 and /or for modification by the user.

The user receives the report in real-time and as stated, can save it for future use and reference. A new search can be run at any time and the results can be compared to the saved search. The report provides notification of new target documents, which have been found, and documents which have been changed textually or whose status has changed. The report includes links to each of the identified target and supporting documents, such that the user can go directly to the websites, if desired. The user can add notes to each of the document summaries, again as desired. The user can provide an indication of the user's or the organization's position on each target document. The user can indicate their opinion of the probability of successful passage of the document through the process and the impact on the organization or other entity that is interested in the outcome of the document. The user also has the option of removing target and supporting documents from any subsequent reports. The user has the ability to always track an identified target document, even though the search expression within the target document may subsequently be removed. In addition (and also not illustrated), the user can select any number of target documents and generate a URL, which can be clicked on by a user or anyone who is sent the URL, to cause a report to be generated, which report includes only the selected target documents.

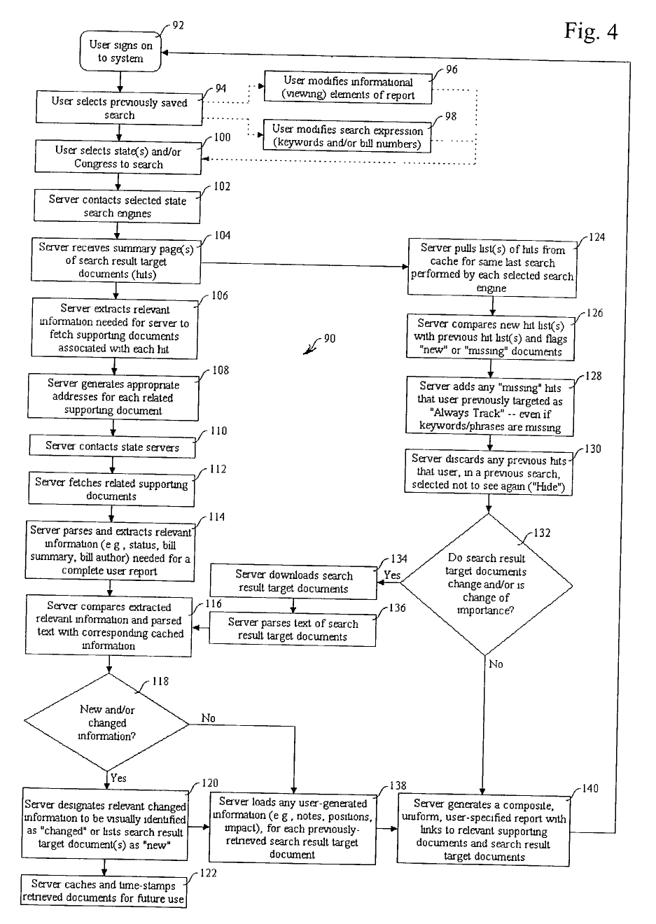

Referring now to FIG. 4, a first detailed saved search embodiment flow chart 90 is illustrated. Where the functions of the steps are identical or substantially identical to those already described, the details will not be repeated. The user again signs on in a step 92 and selects one of the previously saved searches in a step 94. At that point the user can modify how the report will be formatted in a step 96 and/or modify the search expression in a step 98 or the user may leave the search unchanged. The user selects the search entities in a step 100 and the entities are contacted in a step 102. The summary pages of the target documents located are obtained in a step 104. The supporting document information is extracted in a step 106 and the URL addresses are generated in a step 108. The entities are again contacted in a step 110 and the supporting documents are obtained in a step 112. The supporting documents are parsed and the report information is extracted in a step 114 and this information is then compared with that cached from the previous search in a step 116. If there is new information as determined in a step 118, then the relevant information is designated as new or changed in a step 120 and the information is cached and time-stamped for future use in a step 122.

Following the step 104, the list of hits for the last search are pulled for each search entity in a step 124 and compared with the new hit list in a step 124 and any new or missing documents are flagged. Any missing hits that have been designated as always being tracked by the user are added in a step 128, even though they do not include the search expression. Any hits that the user has selected not to see are discarded in a step 130. A decision then is made in a step 132 on whether or not the target documents will change and if so, whether the change is of importance. If the answer is yes, then the target documents are obtained in a step 134 and parsed in a step 136. The previous target documents then are compared with the cached information in the step 116 and the determination of new/or-changed information is made in the step 118. If the determination is yes, then the steps 120 and 122 are performed as before. If the determination is no and/or following the step 120, then any user-generated information (such as notes, positions, impact, etc.) are loaded for each previously retrieved document in a step 138. Then, following the step 138 or a no decision in the step 132, a composite report user specified report is generated with links to the target and supporting documents, stored and sent to the user in a step 140.

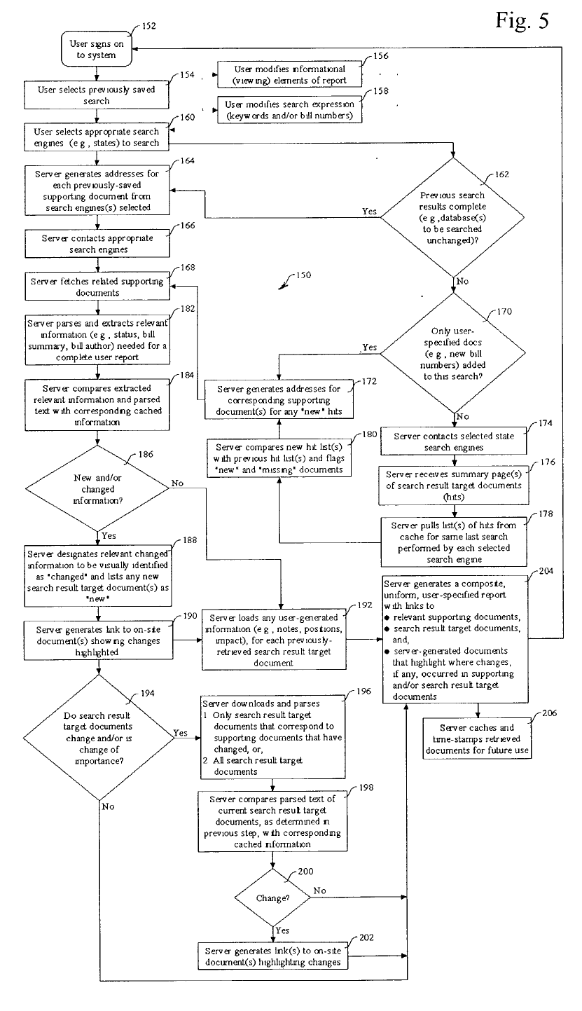

A second detailed saved search embodiment flow chart 150 is illustrated in FIG. 5. The user signs on in a step 152 and selects a previously saved search in a step 154. The user again can modify the report format, if desired, in a step 156 and the search expression in a step 158. With or without modifications, the user then selects the search entities in a step 160. At this step, a new feature is added in a step 162 to determine if the databases being searched are static or complete (i.e., have stopped adding new documents, normally due in the legislative process to the imposition of deadlines for the introduction of new legislation). If the answer is yes and the previous search is complete, then the addresses for the previously saved supporting documents are generated in a step 164. The selected entities then are contacted in a step 166 and the supporting documents are obtained in a step 168.

On the other hand, if the decision in the step 162 is no and additional documents may have been added to the databases of the search entities, then a further decision is made in a step 170 to determine if only user specified documents have been added, i.e., only new bill or regulation numbers. If so (yes), then addresses are generated for corresponding supporting documents for any new hits in a step 172 and the documents are obtained in the step 168. If the answer to the step 170 is no, then the selected entities are contacted in a step 174 and the summary pages of the target documents found are obtained in a step 176. The results from the same last search for each entity then are obtained from cache in a step 178 and compared with the new hits to flag the new and missing documents in a step 180. The new hit supporting document addresses then are obtained in the step 172 and the documents obtained in the step 168.

The relevant information for the reports then is parsed and extracted in a step 182 and then compared with the corresponding cached information in a step 184. A decision is made in a step 186 on whether there is any new or changed information. If the answer is yes, then the changed and/or new information is indicated or designated to be visually identified as such in a step 188 and a plurality of links are generated by the server in a step 190 to system-based documents that highlight the changes made to each changed target or supporting document. Notes and other user-generated information from the previously generated searches are loaded in a step 192. The step 192 is performed after the step 186 when there is determined to be no new or changed information.

A decision also is made following the step 190 to determine if the target documents found change and/or if the change is of importance to the user in a step 194. If the answer is yes, then all the documents or optionally, only those that are changed are downloaded and parsed in a step 196. The new parsed information then is compared with the corresponding cached information in a step 198. A determination is made in a step 200 if there are any changes between the new and cached information and if the answer is yes, then links are generated to highlight the changes in a step 202. Following a no decision in the steps 194 and 200 and following the steps 192 and 202, a composite user report is generated in a step 204. The report is generated in the default format or in the user modified format with links to the summary and target documents and the highlighted change/new results and sent to the user as before. The documents are also cached and time-stamped for future use in a step 206.

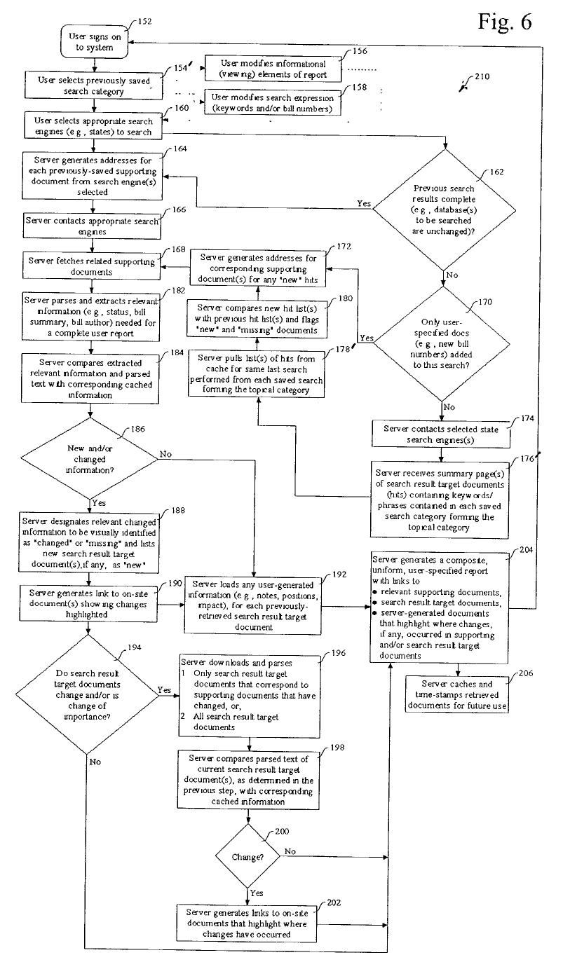

A topical category detailed saved search embodiment flow chart 210 is illustrated in FIG. 6. This search embodiment 210 is desirable, since many of the search entities; especially the state websites 22 do not allow any type of sophisticated search. For example, searching all the state websites for ground water related issues can require many different searches of each of the websites. The key words and phrases for ground water issues can include, among many possibilities, ground water, water pollution, water contamination, leaching, percolation, seepage, etc. A sophisticated search engine would allow several or all of these and any other desirable or related phrases and key words to be combined in one search. Unfortunately, many of the state websites, allow only one of the phrases and keywords to be performed in each search. Therefore, the user will request the search combination or grouping of the saved searches to be performed and the system 10 will retain the logic necessary to perform one or more searches of each website with the search logic required for each website. The search operation is virtually functionally identical to the saved search 150, so the same numbers are utilized in the search 210, with an apostrophe designating the steps, which are modified in the search 210. The user again signs on in the step 152 and then selects a previously saved search category in the step 154′ or modifies a previously saved category in the step 158. The search category, such as ground water, then is searched as previously described, with the exception that most websites will require numerous searches to obtain, all the required information. This is illustrated by the steps 176′ and 178′. The search results are received and compared for each search category (individual or combined searches), which form the topical category being searched. The rest of the search 210 is accomplished as the search 150, but the report of course, in general, will include an increased amount of data from a general more limited search expression.

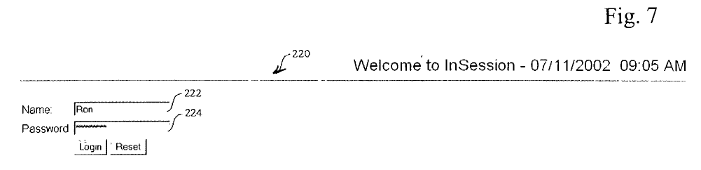

Referring to FIG. 7, an illustration of one embodiment of a login screen shot of the tracking system of the present invention is designated by the numeral 220. Using the search 50, as an example for this and the following screen shots, the user will see the blank screen shot 220 when they sign on in the step 52. The user then signs or logs into the system in a conventional manner by entering their personal account information to access their password secured account, such as their name “Ron” in a field 222 and a password “******” (hidden text) in a field 224.

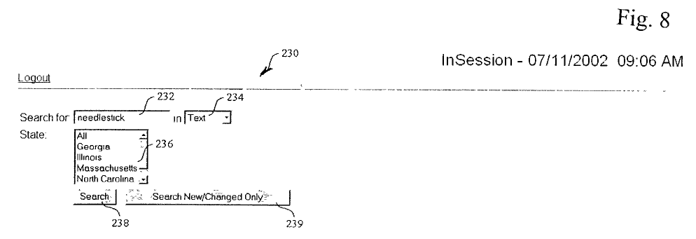

An illustration of one embodiment 230 of a combined search expression and entity screen shot of the tracking system of the present invention is illustrated in FIG. 8. The user has successfully logged in and now can proceed with a search. For an initial or non-saved search, or to set up a saved search, the user enters the search expression “needlestick” in the step 54, in a field 232 and that it is a “text” search in a field 234. The user selects the search entity in the step 56, here “all” states to which the user has subscribed in a field 236 and then initiates the search either by clicking on a “Search” field 238 to view all new and previous target documents that have not been hidden, or by clicking on a “Search New/Changed Only” field 239 to view only those new or changed target document summaries.

FIG. 9 illustrates one embodiment of a composite standard search report screen shot 240 of the tracking system of the present invention. The report 240 includes the search fields 232, 234 and 236, which define the search performed for the report 240. A summary of the results is shown in a field 242, here being two (2) hits or bills in two states. The report format, here the default format, is shown generally in a field 244. A first portion 246 of the field displays the State (for the first hit Illinois), the Bill (HB 3533) and the Author (DART). A second portion 248 of the field displays the Bill Title (HEALTH CARE WORKER PROT ACT), the Summary (below the title) and the Latest Status (date Apr. 6, 2001 and status on that date). The field 244 also includes several note fields, which can be used by the user to provide information related to each specific bill. A first position field (POS) 250, can be used to indicate the position of the user or the user's organization and can be a clickable or drop down field, which can indicate O (oppose), A (amend), N (neutral) or S (support). A probability of passage field (POP) 252 can be used to indicate the user's subjective view of the probability H (high), M (medium) or L (low) of passage of the bill. An impact on the organization field (IMP) 254 again can be indicated as H, M or L. A hide the display field (HID) 256, can be used to remove the bill from view should the bill, for one reason or another, be minimal or of no interest to the user. A save search field 258 is included at the bottom of the report and includes a related name field 260 for the saved search, which can be the search name or can be edited by the user, as desired. An edit notes field 262, is included and can be clicked by the user to enter and edit notes in an expandable field. A save notes field 264 is included and is clicked to save the notes entered in the field 262. As mentioned earlier and not illustrated, the user also can elect to have the system continue to track (“Always Track”) a specific target document by clicking on a field. Another separate field (also not illustrated) allows the user to select target documents of interest and generates a URL that can be sent to others who, when clicking on the URL, will see a report which only includes the target documents selected by the user.

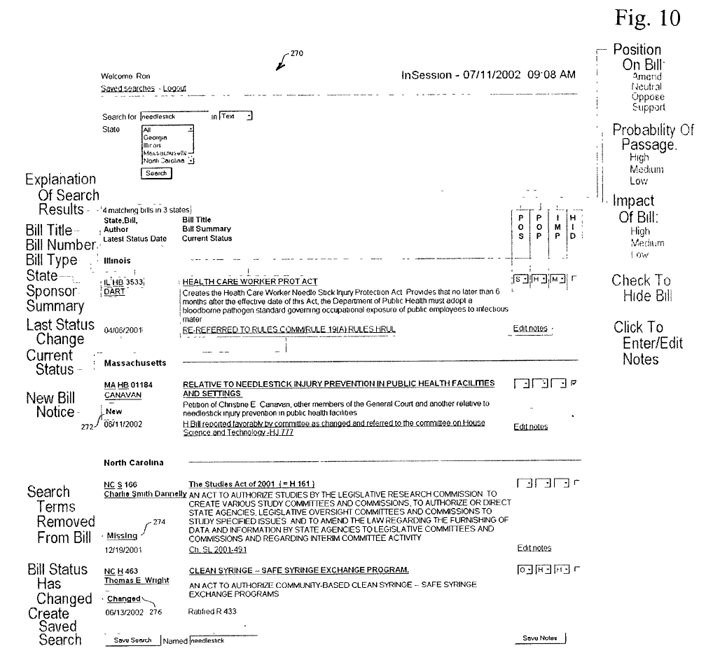

FIG. 10 illustrates one embodiment of a saved search report screen shot 270 of the tracking system of the present invention. The report 270 is very similar to the report 240, but includes indications or flags, which indicate new or changed status. A New notice 272 is included with the MA HB 01184 to show that it is new with this report/search. Likewise, a Missing notice 274 is included with NC S 166 to show that the search term “needlestick” now has been removed from the document. A Changed notice 276 is included with the NC H 463 to indicate that the status of the bill has changed from the last search report.

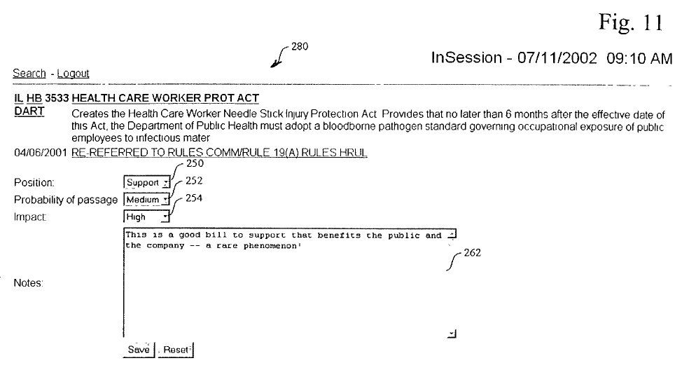

FIG. 11 illustrates one embodiment of an edit notes screen shot 280 of the tracking system of the present invention. By clicking on the edit notes field 262, the field expands to accommodate whatever notes the user may wish to enter. The user also can enter the desired selection in the fields 250, 252 and/or 254.

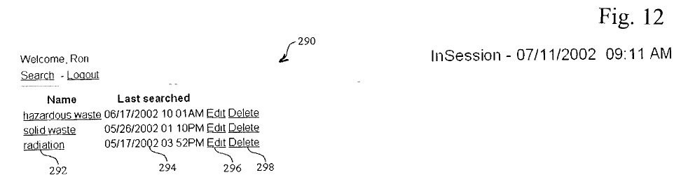

FIG. 12 illustrates one embodiment of a user saved search screen shot 290 of the tracking system of the present invention. The user selects the appropriate saved search to form the basis of a new or updated search to search and review the legislative or regulatory issues. The saved search categories are defined by key words or phrases and/or bill or regulation number parameters. The saved searches are listed in a name field 292, such as a hazardous waste search, a date of last search field 294, Jun. 17, 2002, an edit field 296 is provided for editing a search before using it again and a delete field 298 is provided to delete any unwanted or no longer useful searches.

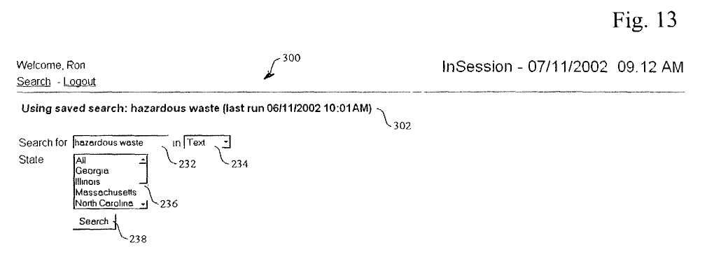

FIG. 13 illustrates one embodiment of implementing a search of a user saved search as shown by a screen shot 300 of the tracking system of the present invention. The screen shot 300 is the same as the shot 230, except a saved search indication and date are provided in a field 302. The saved search “hazardous waste” is entered for the search expression in the field 232 and three states Georgia, Illinois and Massachusetts are selected in the search entity filed 236.

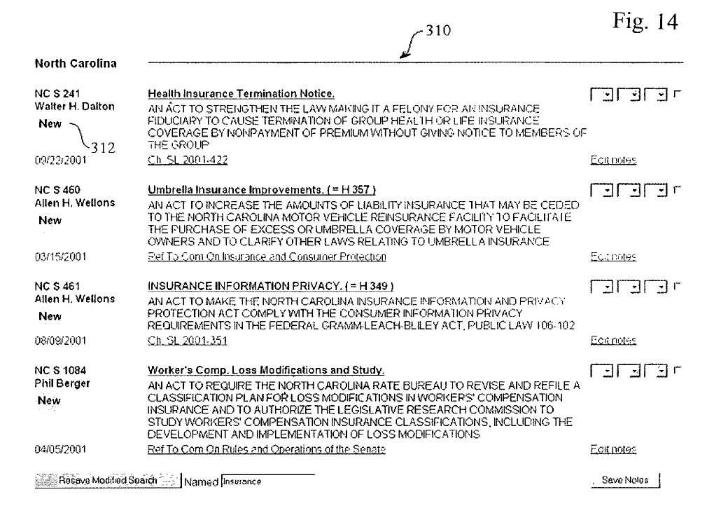

FIG. 14 illustrates one embodiment of a search report 310 from a search of a user saved search screen shot of the tracking system of the present invention. The search report 310 is the same as other search reports, except that a field 312 is included which shows “new” for each bill or regulation added since the last time the search was run. In this case each of the bills is indicated as new, since the new state North Carolina has been added to the search entities. The “New” label also will be added if a bill has been amended to include the search expression since the last search.

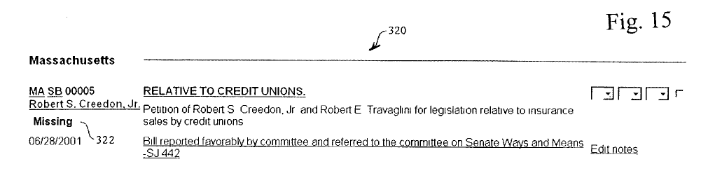

FIG. 15 illustrates a second embodiment of a search report 320 from a search of a user saved search screen shot of the tracking system of the present invention. The search report 320 is the same as other search reports, except that a field 322 is included which shows “Missing” for each bill or regulation where the search expression has been deleted since the last time the search was run. The user then can decide if the amended bill should be retained.

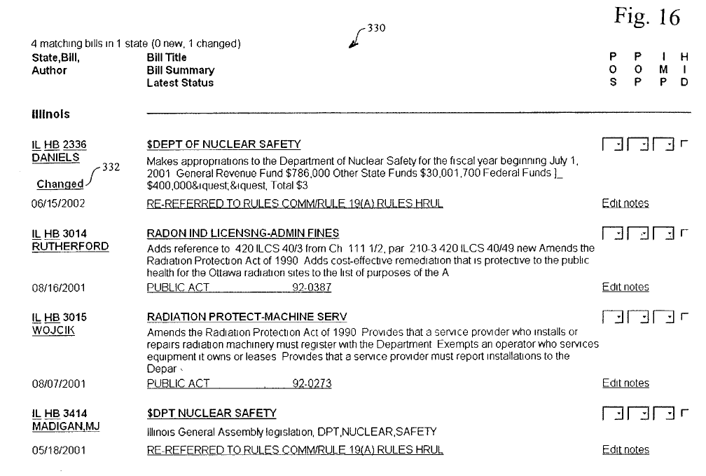

FIG. 16 illustrates a third embodiment of a search report 330 from a search of a user saved search screen shot of the tracking system of the present invention. The search report 330 again is the same as other search reports, except that a field 332 is included which shows “Changed” for each bill or regulation where the status has changed since the last time the search was run.

As to a further discussion of the manner of usage and operation of the present invention, the same should be apparent from the above description. It should be noted that such invention can be utilized by the established commercial services, utilizing their databases to search for legislation that they have obtained the night before via crawling the state legislative databases, then obtain the supporting information (e.g., the bill status) from the state databases on a real time basis. Accordingly, no further discussion relating to the system structure and operation will be provided. Therefore, the foregoing is considered as illustrative only of the principles of the invention. Further, since numerous modifications and changes will readily occur to those skilled in the art, it is not desired to limit the invention to the exact system construction and operation shown and described, and accordingly, all suitable modifications and equivalents may be resorted to, falling within the scope of the claims of the present invention.

1. A method of finding and tracking the status of a target document in a legislative, regulatory or similar process in a state or other entity, comprising:
entering a search expression;
selecting at least one entity to be searched using the search expression;
searching the selected entity for target documents containing said search expression;
extracting information from each said target document found in said search to identify associated supporting documents;
using said extracted information to obtain all relevant desired status and related information from each of said associated supporting documents; and
generating a composite report of said status and related information of each of said target documents found in said search.

2. The method of claim 1, including obtaining copies of the target documents found in said search.

3. The method of claim 1, including said search entity including at least one state legislative website and using the Internet to search said website for said search expression.

4. The method of claim 3, including a plurality of said state websites, which can be searched, and selecting one or more of said websites to be searched for said search expression.

5. The method of claim 1, including using the Internet to perform said search and including links in said composite report to each target and relevant supporting document found in said search.

6. The method of claim 1, including saving said target and supporting documents for reference and for use in future searches.

7. The method of claim 6, including using said saved target documents to perform a new search.

8. The method of claim 7, including modifying said search expression before performing the new search.

9. The method of claim 7, including comparing the saved information with the information found in the new search.

10. The method of claim 9, including indicating any changed information in said report.

11. The method of claim 9, including any new target documents in said report.

12. The method of claim 1, including obtaining a summary page for each target document found in said search.

13. The method of claim 12, including parsing each summary page to obtain the summary documents.

14. The method of claim 1, including obtaining each supporting document found in said search.

15. The method of claim 14, including parsing each supporting document to obtain all relevant supporting information.

16. The method of claim 1, including indicating a support position on each said target document in said report.

17. The method of claim 1, including indicating a probability of passage of each said target document in said report.

18. The method of claim 1, including indicating a possible impact of the passage of each said target document in said report.

19. The method of claim 1, including entering notes about at least some of said target documents in said report.

20. The method of claim 1, including selecting some of said target documents and generating a URL and generating a composite report of said status and related information of each of said selected target documents when said URL is accessed.

21. The method of claim 1, including continuing to track a target document even though said target document no longer contains said search expression.
